(19) United States
(12) Patent Application Publication
(10) Pub. No.: US 2024/0052833 A1
(43) Pub. Date: Feb. 15, 2024

(54) PUMP SYSTEM HAVING MOTOR AND PUMP CONTROLLER

(71) Applicant: TI AUTOMOTIVE TECHNOLOGY CENTER GMBH, Rastatt (DE)

(72) Inventors: Garrett TETIL, Deford, MI (US); Brian MIDDLETON, Mayville, MI (US); Andrew PECKHAM, Bay City, MI (US)

(73) Assignee: TI AUTOMOTIVE TECHNOLOGY CENTER GMBH, Rastatt (DE)

(21) Appl. No.: 17/884,123

(22) Filed: Aug. 9, 2022

(51) Int. Cl. F04C 14/08; F04B 17/03; F04B 49/06

(52) U.S. Cl. CPC F04C 14/08; F04B 17/03; F04B 49/06

(57) ABSTRACT

A pump system for a vehicle having an electronic control unit (ECU) for operating the pump system includes a pump assembly having a motor and a pump controller with a command input communicating with the ECU of the vehicle. The pump controller is configured to determine whether a command input of the pump controller is selectively connected to the ECU of the vehicle, and also the pump controller is operable in at least two modes including a first mode which utilizes a valid pulse width modulation (PWM) input from the ECU when the pump controller is in communication with the ECU and a second mode which utilizes a discrete digital input for controlling a speed of the pump assembly when the pump controller is not in communication with the ECU.

### FIELD

The present disclosure relates to a pump system having a pump controller, and particularly relates to the pump controller having the control circuit with multi-function commands.

### BACKGROUND

The statements in this section merely provide background information related to the present disclosure and may not constitute prior art.

Generally, in a vehicle, pump controllers operate pumps, which are each installed in a fuel system and/or a coolant system. In particular, the pumps are generally driven by a motor (e.g., a brushless direct current (BLDC) motor). For example, The BLDC motor having a rotor rotated by the sequential switching of electromagnetic coils placed in the stator. In the BLDC motor, control of a revolution number is conducted by detecting magnetic pole positions of the rotor, i.e., the relative positions between the magnetic rotor and stator windings due to the velocity electromotive force which is induced across the stator windings of the BLDC motor. The relative position between the rotor and the stator windings are assumed or obtained, thereby it is possible to perform the control of rotation speed of the BLDC motor depending upon a result of that assumption.

The motor installed in the fuel pump system or the coolant pump system is generally controlled by an electronic control unit (ECU) of the vehicle such that the speed of the pumps having the motor is adjusted according to a pulse width modulation (PWM) signal from the ECU of the vehicle. The ECU of the vehicle communicates with a plurality of controllers to operate various systems in the vehicle. In particular, the ECU of the vehicle is communicated with a pump controller for operating the motor to adjust the speed of the pump in the fuel pump system or the cooling pump system of the vehicle. In a conventional pump controller, to additionally create the function of the pump controller for adjusting the speed of the pump, additional hardware or wiring systems in the pump assembly are generally needed and it adds cost and weight.

### SUMMARY

The present disclosure relates to a pump system having a pump assembly and a pump controller, which can adjust a speed of the pump according to a command input of the pump controller circuit. According to one aspect of the present disclosure, the pump system for a vehicle having an electronic control unit (ECU) for operating the pump system includes a pump assembly having a motor and a pump controller with a command input communicating with the ECU of the vehicle. The pump controller is configured to determine whether a command input of the pump controller is selectively connected to the ECU of the vehicle and also is operable in at least two modes including a first mode which utilizes a valid pulse width modulation (PWM) input from the ECU when the pump controller is in communication with the ECU and a second mode which utilizes a discrete digital input for controlling a speed of the pump assembly when the pump controller is not in communication with the ECU.

According to a further aspect of the present disclosure, when the pump controller determines that the command input of the pump controller is not connected to the ECU of the vehicle, the pump controller is configured to utilize the discrete digital input and adjust a speed of the pump having the motor with a constant value. When the command input of the pump controller is left unconnected, the pump controller is configured to adjust the speed of the pump having the motor with a constant low speed. When the command input of the pump controller is connected to a ground, the pump controller is configured to adjust the speed of the pump having the motor with a constant high speed. Especially, for aftermarket uses or when otherwise replacing a pump controller, some end-users may not have access to a PWM output or simply don't want to implement variable speed control. Accordingly, an end-user can configure the pump controller multiple configurations, i.e. for variable speed PWM control or for discrete pump speed control (high or low). The system and controller of the present disclosure allows the end-user to ignore the traditional PWM command, and statistically set the pump to either high speed or low speed, all utilizing the same PWM wire.

According to a further aspect of the present disclosure, when the pump controller determines that the command input of the pump controller is connected to the ECU of the vehicle to detect the valid PWM input, the pump controller is configured to utilize the valid PWM input as a frequency cycle or a duty cycle. The pump controller receiving the valid PWM input is configured to adjust a speed of the pump having the motor according to the frequency cycle or the duty cycle.

According to a further aspect of the present disclosure, the pump system further includes a relay switch connected to the pump controller to provide a power transfer.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a plan view of a pump assembly in accordance with an exemplary form of the present disclosure;

FIG. 2 shows a wiring diagram of a pump system having the pump assembly of FIG. 1;

FIGS. 3 and 3A show circuit schematic views of the pump controller in the pump assembly of FIG. 1; and

FIG. 4 shows a logic flow diagram of the pump controller of FIG. 2.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

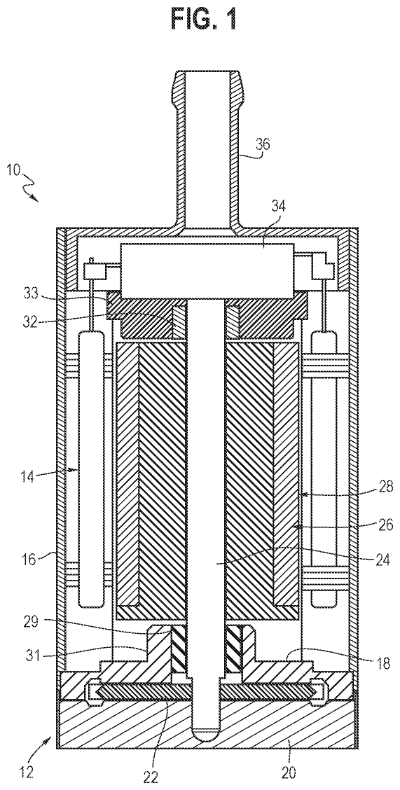

The present disclosure relates to a pump assembly used in a fuel system and/or a cooling system in a vehicle. As an example, FIG. 1 shows a fuel pump assembly 10 mounted in a vehicle (not shown) and powered by an on-board battery system. The pump assembly 10 described in the present disclosure can be also used in the cooling system of the vehicle. As shown in FIG. 1, for example, the pump assembly 10 includes a pump 12 and a motor (e.g., a brushless DC (BLDC) motor) 14 integrally housed in a cylindrical housing 16. Further, the pump 12 includes a pump casing 18, a pump cover 20, and an impeller 22 fixedly housed in the bottom portion of the housing 16. Both the pump casing 18 and the pump cover 20 are fixed to the housing 16 by caulking or press-fitting and form a pump chamber therebetween in which the impeller 22 is rotatably supported. The impeller 22 is fixedly connected to a shaft 24 of the BLDC motor 14.

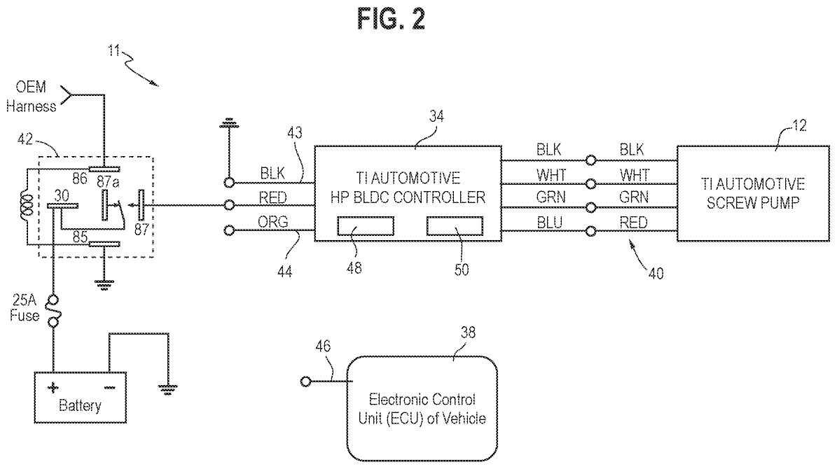

In FIG. 1, for example, the BLDC motor 14 is a motor driven by a five-phase armature winding and is composed of a cylindrical stator 26 fixedly housed in the housing 16 and a magnet rotor 28 rotatably supported in the housing 16. The bottom end of the shaft 24 is rotatably supported by a first bearing 29 fixed to a first bearing holder 31 of the pump casing 18. The upper end of the shaft 24 is rotatably supported by a second bearing 32 held by a second bearing holder 33 which is fixedly housed in the housing 16. Further, the pump 12 includes a pump controller 34 that controls power supply to the armature winding in the stator 26 and also adjusts the speed of the pump. In FIG. 1, for example, the pump controller 34 is located in the upper end of the shaft 24, but in accordance with other forms of the present disclosure, the pump controller 34 having a microcontroller 48 and a memory 50 may be located at any locations of the pump 12 (see FIG. 2).

When the impeller 22 of the pump 12 is driven by the BLDC motor 14, for example, fuel in a fuel tank (not shown) is sucked into the pumping chamber through an inlet port (not shown) and is pumped out from an outlet port (not shown) of the pumping chamber into an inner space of the housing 16. The fuel entered the housing 16 flows through a gap between the magnet rotor 28 and stator 26, and is applied to injectors (not shown) through the outlet port 36.

FIG. 2 shows a wiring block diagram of the pump system 11 having the pump controller 34 that communicates with an electronic control unit (ECU) 38 of the vehicle (not shown) and also adjusts the speed of the BLDC motor 14 to control the pump 12 according to the command of the ECU 38. As shown in FIG. 2, the pump controller 34 is connected to the BLDC motor 14 in the fuel pump 12 via the wiring arrangements 40 such that the pump controller 34 can control the speed of the pump 12 having the BLDC motor 14. For the effective communication between the pump controller 34 and the BLDC motor 14 in the fuel pump 12, the wiring arrangements 40 between the pump controller 34 and the BLDC motor 14 are simplified and also securely connected to each other. Accordingly, the wiring arrangements 40 must be robust without any failure. For example, a soldering method for the wiring arrangements 40 is generally used to connect each other. Further, end-to-end resistance for any phase wire is less than 100 mΩ to reduce any failure risk of the pump performance.

In FIG. 2, the pump controller 34 is further connected with a relay switch 42, which is electrically operated. Generally, the relay switch 42 uses an electromagnet (coil) to operate their internal mechanical switching mechanism (contacts), and is used extensively throughout vehicle electrical systems. Further, the switching circuit of the relay switch 42 does not require a high current rated switch or cable which reduces such that it reduces cost and weight. The relay switch 42 can be positioned anywhere in the vehicle to provide efficient power transfer to the electrical accessory for controlling. As shown in FIG. 2, for example, the relay switch 42 is positioned close to the fuel pump 12 having the pump controller 34 to control the BLDC motor 14.

In FIG. 2, the relay switch 42 is a 5 pin relay, which is used to switch power between two circuits. As shown in FIG. 2, the 5 pin relay switch provides two (2) pins (85 & 86) to control the coil and three (3) pins (30, 87, and 87A) which switch power between two circuits. They have both normally open and normally closed connection pins. For example, when the coil is activated, power will be switched from the normally closed pin to the normally open pin. Two circuits (terminals 87 and 87a) have a common terminal (30), and when the relay is at rest, terminal 87a is connected to terminal 30 (see FIG. 2). Further, when the relay is energized, terminal 87 becomes connected to terminal 30, but never connected to both terminals (87 and 87a) at the same time.

In addition, as shown in FIG. 2, the coil connected between the two pins (85 & 86) should be fed with +12V to terminal 86 and grounded via terminal 85. Further, the current carrying capacity of the high current circuit is normally between 25 A and 40 A. Terminal 30 is further connected to a battery and terminal 86 may be connected to OEM harness when the pump controller 34 with the relay switch 42 is assembled with aftermarket vehicles such that the pump controller 34 can control the pump assembly in the aftermarket vehicle.

As shown in FIG. 2, further, the pump controller 34 includes a ground input 43 connected to a ground and also a command input 44 which receives a pulse width modulation (PWM) signal from the ECU 38 of the vehicle. In addition, the command input 44 is exploited to have additional functions of the pump controller 34 to adjust the speed of the pump 12. Typically, a valid pulse width modulation (PWM) signal is used in conjunction with a transfer function, to simply command the pump speed (i.e., the BLDC motor's speed) or open-loop voltage over a predetermined range. In the present disclosure, the command input 44 of the pump controller 34 is selectively connected to an output 46 of the ECU 38 in the vehicle to control the pump assembly 10, and further the command input 44 of the pump controller 34 is selectively connected to a ground such that the pump controller 34 can adjust the speed of the pump 12 in the pump assembly 10 without adding any hardware or wiring systems. The valid PWM signal typically comes from the ECU 38 of the vehicle to implement variable speed of the BLDC motor 14. However, some end-users may not have access to the output 46 of the ECU 38, or simply don't want to implement variable speed control by the valid PWM signal. Instead, they may want to control discrete pump speeds via the selective connections of the command input 44 as an additional function of the pump 12.

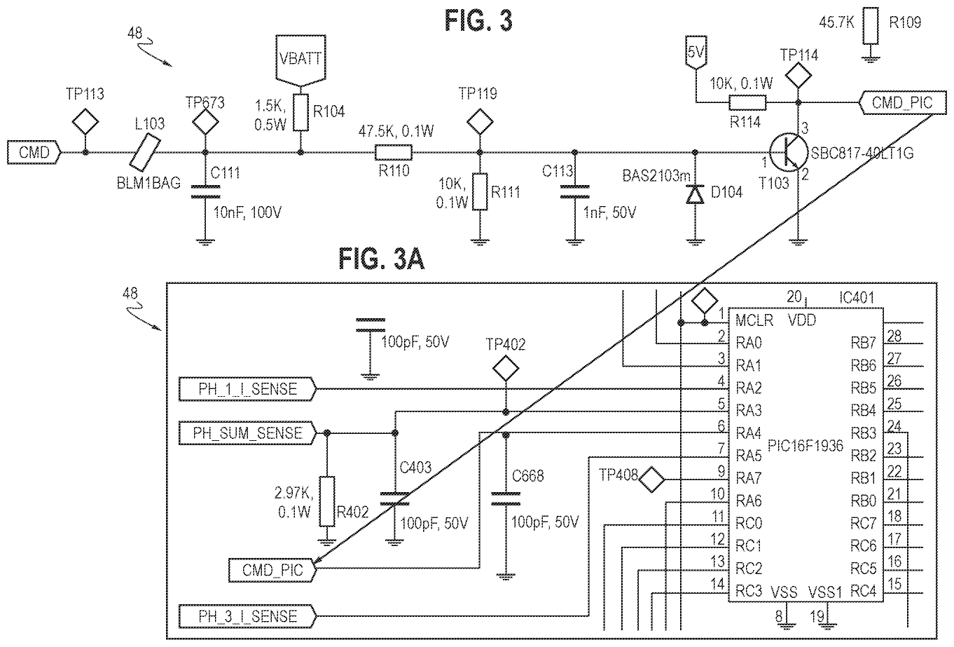

In FIG. 2, the output 46 of the ECU 38 can be connected to the command input 44 of the pump controller 34 and the valid PWM signal from the ECU 38 of the vehicle is transferred via the connected line between the pump controller 34 and the ECU 38. As described above, the pump speed will typically follow the supplied transfer function when the valid PWM signal is transferred such that the speed of the pump is controlled according to the output of the transfer function. According to an exemplary embodiment of the present disclosure, the command input 44 of the pump controller 34 may be connected to the ground or is left unconnected to control the pump assembly 10 with additional functions. When the connected line between the command input 44 and the output 46 of the ECU 38 is disconnected and leaves the command input 44 unconnected, the internal circuitry of the pump controller 34 pulls-up the input command to be a high level of the voltage (i.e., the base of the transistor (T103) is pulled high to Vbatt, see FIG. 3) such that the pump controller 34 is configured to interpret the input command as a “max speed” of the pump assembly 10 and run the pump 12 constant at the maximum speed, which is defined as one of the additional functions without adding any hardware or wiring systems.

When the connected line between the command input 44 of the pump controller 34 and the output 46 of the ECU 38 is disconnected and the command input 44 is connected to the ground, the internal circuitry of the pump controller 34 pulls down the input command to be a low level (i.e., the base of the transistor (T103) is pulled down to ground, see FIG. 3) such that the pump controller 34 is configured to interpret the input command as a “low speed” of the pump assembly 10 and runs the pump 12 constant at minimum speed, which is defined as another function of the additional functions. Accordingly, the additional functions of the pump assembly 10 in the present disclosure allow the pump controller 34 to ignore the valid PWM signal, and statistically set the fuel pump 12 to enter constant high speed or low speed with the same hardware including the wire arrangements 40. Further, the pump controller is generally configured to set the fuel pump to enter any constant speed including the high and low speed. As described above, the pump controller 34 having the additional functions such as the discrete command having any static speed of the pump can be also utilized in the aftermarket vehicles. In another approach, the pump controller 34 of the present disclosure may be utilized in a cooling system of the vehicle.

FIGS. 3 and 3A show circuit schematic views of the pump controller 34 having the microcontroller 48. In FIGS. 3 and 3A, when the output 46 of the ECU 38 in the vehicle is connected to the command input 44 (i.e., a valid PWM signal is transmitted to the pump controller 34 via the command input 44), the pump controller 34 converts the signal amplitude to 5V, and sends the signal amplitude as an input on the pump controller 34 to control the pump assembly 10. In FIGS. 3 and 3A, when the valid PWM signal is transmitted, the pump controller 34 utilizes the input (i.e., a register counter input (RA4)) as a frequency cycle or a duty cycle such that the speed of the pump 12 can be adjusted according to the frequency cycle or the duty cycle. If the pump controller does not detect a valid PWM signal, a decision is made to ignore the register counter input (RA4) and utilizes the register counter input (RA4) as a discrete digital input. As shown in FIGS. 2, 3, and 3A, if the command input 44 is left unconnected, then the base of transistor (T103) is pulled high to Vbatt, which is seen as logic low to the register counter input (RA4) such that the pump 12 is directed to run at the maximum speed of the pump 12 or a constant high speed (e.g., greater than 50% of the maximum speed). Further, if the command input 44 is connected to a ground, the base of the transistor T103 is pulled to ground, which is seen as logic high to the register counter input (RA4) such that the pump 12 is directed to run at the minimum speed of the pump 12 or a constant low speed (e.g., less than 50% of the maximum speed).

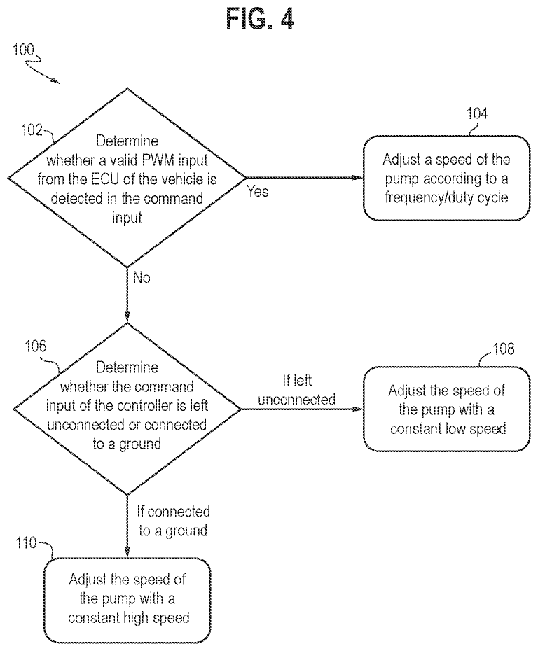

FIG. 4 shows a flow chart 100 of the pump controller 34 in accordance with an exemplary embodiment of the present disclosure. In step 102, the pump controller 34 is configured to determine whether a valid PWM input (signal) from the ECU 38 of the vehicle is detected in the command input 44. In step 104, if the valid PWM input (signal) from the ECU 38 of the vehicle is detected, the pump controller 34 is configured to utilize the input (signal) as a frequency cycle or a duty cycle such that the pump controller 34 controls the speed of the pump according to the frequency cycle of the duty cycle. In step 106, if the valid PWM signal from the ECU 38 is not detected, the pump controller 34 is configured to determine whether the command input 44 of the controller 34 is left unconnected or connected to a ground. In step 108, if the command input 44 of the controller 34 is left unconnected, the pump controller 34 is configured to adjust the speed of the pump with a constant low speed or a minimum speed. In step 110, if the command input 44 of the controller 34 is connected to the ground, the pump controller 34 is configured to adjust the speed of the pump with a constant high speed or a maximum speed. Accordingly, in the present disclosure, the pump controller 34 of the pump assembly 10 can control additional functions such as any static speeds of the pump 12 without additional hardware or wiring systems.

The methods, devices, processors, modules, engines, and logic described above may be implemented in many different ways and in many different combinations of hardware and software. For example, all or parts of the implementations may be circuitry that includes an instruction processor such as a Central Processing Unit (CPU), microcontroller, or a microprocessor, an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry includes discrete interconnected hardware components and/or is combined on a single integrated circuit die, distributed among multiple integrated circuit dies, or implemented in a Multiple Chip Module (MCM) of multiple integrate circuit dies in a common package, as examples.

The circuitry further includes or accesses instructions for execution by the circuitry. The instructions is stored in a tangible storage medium that is other than a transitory signal, such as a flash memory, a Random Access Memory (RAM), a Read Only Memory (ROM), a Erasable Programmable Read Only Memory (EPROM); or a magnetic or optical disc, such as a Compact Disc Read Only Memory (CDROM), Hard Disk Drive (HDD), or other magnetic or optical disk; or in or on another machine-readable medium. A product, such as a computer program product, includes a storage medium, and instructions stored in or on the medium, and the instructions when executed by the circuitry in a device cause the device to implement any of the processing described above or illustrated in the drawings.

The implementations is distributed as circuitry among multiple system components, such as among multiple processors and memories, optionally including multiple distributed processing systems. Parameters, databases, and other data structures is separately stored and managed, is incorporated into a single memory or database, is logically and physically organized in many different ways, and is implemented in many different ways, including as data structures such as linked lists, hash tables, arrays, records, objects, or implicit storage mechanisms. Programs is parts (e.g., subroutines) of a single program, separate programs, distributed across several memories and processors, or implemented in many different ways, such as in a library, such as a shared library (e.g., a Dynamic Link Library (DLL)). The DLL, for example, stores instructions that perform any of the processing described above or illustrated in the drawings, when executed by the circuitry.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A pump system for a vehicle having an electronic control unit (ECU) for operating the pump system, the pump system comprising:
a pump assembly including a motor; and
a pump controller with a command input communicating with the ECU of the vehicle,
wherein the pump controller is configured to determine whether the command input of the pump controller is selectively connected to the ECU of the vehicle, and
wherein the pump controller is operable in at least two modes including a first mode which utilizes a valid pulse width modulation (PWM) input from the ECU when the pump controller is in communication with the ECU and a second mode which utilizes a discrete digital input for controlling a speed of the pump assembly when the pump controller is not in communication with the ECU.

2. The pump system of claim 1, wherein when the pump controller determines that the command input of the pump controller is not connected to the ECU of the vehicle, the pump controller is configured to utilize the discrete digital input and adjust a speed of the pump having the motor with a constant value.

3. The pump system of claim 2, wherein when the command input of the pump controller is left unconnected, the pump controller is configured to adjust the speed of the pump having the motor with a constant low speed.

4. The pump system of claim 2, wherein when the command input of the pump controller is connected to a ground, the pump controller is configured to adjust the speed of the pump having the motor with a constant high speed.

5. The pump system of claim 1, wherein when the pump controller determines that the command input of the pump controller is connected to the ECU of the vehicle to detect the valid PWM input, the pump controller is configured to utilize the valid PWM input as a frequency cycle or a duty cycle.

6. The pump system of claim 5, wherein the pump controller receiving the valid PWM input is configured to adjust a speed of the pump having the motor according to the frequency cycle or the duty cycle.

7. The pump system of claim 1, wherein the pump system further includes a relay switch connected to the pump controller to provide a power transfer.

8. A method for controlling a pump system communicating with an electronic control unit (ECU) of a vehicle, the method comprising the steps of:
providing a pump assembly with a motor and a pump controller having a command input;
determining a connection of the command input;
generating an output signal according to the determined connection of the command input, the output signal based on a valid pulse width modulation (PWM) input when the pump controller is connected to the ECU and the output signal based on a discrete digital input when the pump controller is not connected to the ECU; and
adjusting a speed of the pump having the motor according to the input.

9. The method of claim 8, wherein the step of determining the connection of the command input of the pump controller includes the steps of:
determining to be connected with the ECU of the vehicle;
determining to be left unconnected; or
determining to be connected with a ground.

10. The method of claim 9, wherein if it is determined to be left unconnected, the pump controller is configured to utilize the discrete digital input.

11. The method of claim 10, further comprising the step of adjusting the speed of the pump having the motor with a constant low speed.

12. The method of claim 9, wherein if it is determined to be connected with a ground, the pump controller is configured to utilize the discrete digital input.

13. The method of claim 12, further comprising the step of adjusting the speed of the pump having the motor with a constant high speed.

14. The method of claim 9, wherein if it is determined to be connected with the ECU of the vehicle, the pump controller is configured to utilize the valid PWM input.

15. The method of claim 14, further comprising the step of adjusting the speed of the pump having the motor according to a frequency cycle or a duty cycle from the valid PWM input.
